(19) United States
(12) Patent Application Publication
(10) Pub. No.: US 2018/0086302 A1
(43) Pub. Date: Mar. 29, 2018

(54) AIRBAG DEVICE

(71) Applicant: TOYODA GOSEI CO., LTD., Kiyosu-shi (JP)

(72) Inventors: Takuya HIRAIWA, Kiyosu-shi (JP); Takashi IIDA, Kiyosu-shi (JP); Koji KAWAMURA, Kiyosu-shi (JP); Masaaki OKUHARA, Kiyosu-shi (JP)

(21) Appl. No.: 15/677,273

(22) Filed: Aug. 15, 2017

(30) Foreign Application Priority Data
Sep. 26, 2016 (JP) 2016-187033

(51) Int. Cl. B60R 21/261; B60R 21/233; B60R 21/2334; B60R 21/231; B60R 21/207

(52) U.S. Cl. CPC B60R 21/261; B60R 21/233; B60R 2021/0032; B60R 21/23138; B60R 21/207; B60R 21/2334

(57) ABSTRACT

An airbag is deployed and inflated by inflating gas discharged from a plurality of gas discharge portions. The airbag is divided into a plurality of inflation chambers. At least one of the inflation chambers is an independent inflation chamber that restricts flow of inflation gas to and from adjacent ones of the inflation chambers. Two or more of the inflation chambers including the independent inflation chamber are discharge inflation chambers, each including the gas discharge portion. The gas discharge portions include a first gas discharge portion that starts discharging the inflation gas at a first timing and a second gas discharge portion that starts discharging the inflation gas at a second timing, which differs from the first timing. The first discharge portion is arranged in at least one of the independent inflation chambers.

### BACKGROUND OF THE INVENTION

The present invention relates to an airbag device that deploys and inflates an airbag at a portion proximate to an occupant seated on a vehicle seat when an impact is applied to a vehicle during a collision or the like to protect the occupant from the impact.

An airbag device is effective as a device that protects an occupant from an impact applied to an automobile during a collision or the like. One type of an airbag device known in the art includes, for example, a gas discharge device, which has a gas discharge portion that discharges inflation gas, and an air bag, which is deployed and inflated by the inflation gas. Japanese Laid-Open Patent Publication No. 2007-98991 (FIG. 11) describes an example of an airbag device including an airbag divided into two chambers, namely, an upper inflation chamber and a lower inflation chamber. The inflation chambers are independent inflation chambers that restrict the flow of inflation gas to and from the adjacent inflation chambers. The two inflation chambers are discharge inflation chambers, each including a gas discharge portion. In the airbag, an elongated gas discharge device traverses the two discharge inflation chambers. A first gas discharge portion, which is located at an upper end of the gas discharge device, is arranged in the upper discharge inflation chamber, and a second gas discharge portion, which is located at a lower end of the gas discharge device, is arranged in the lower discharge inflation chamber. Thus, the same gas discharge device can be used to supply inflation gas from the first gas discharge portion and the second gas discharge portion to the discharge inflation chambers, in which the first gas discharge portion and the second gas discharge portion are arranged, and deploy and inflate the discharge inflation chambers.

In the above publication, the amount of inflation gas discharged out of the first gas discharge portion differs from that discharged out of the second gas discharge portion so that the amount of the supplied inflation gas differs between the discharge inflation chambers.

### SUMMARY OF THE INVENTION

However, in the airbag device of the above publication, the discharge of inflation gas out of the first gas discharge portion and the second gas discharge portion of the same gas discharge device starts simultaneously. Thus, the two discharge inflation chambers start deploying and inflating simultaneously. Accordingly, it is difficult to start deploying and inflating the two discharge inflation chambers at separate timings.

In addition to an airbag device in which all inflation chambers of an airbag are independent inflation chambers, the same problem would occur in an airbag device in which at least one of the inflation chambers is an independent inflation chamber. In this case, it would be difficult to start deploying and inflating at least one independent inflation chamber at a timing that differs from that of the other discharge inflation chambers.

It is an object of the present invention to provide an airbag device that starts deploying and inflating at least one independent inflation chamber and other discharge inflation chambers at separate timings.

To achieve the above object, an airbag device includes a gas discharge device and an airbag. The gas discharge device includes a plurality of gas discharge portions that discharge inflation gas. The airbag is deployed and inflated by the inflating gas discharged from the gas discharge portions. The airbag is divided into a plurality of inflation chambers. At least one of the inflation chambers is an independent inflation chamber that restricts flow of inflation gas to and from adjacent ones of the inflation chambers. Two or more of the inflation chambers including all the independent inflation chambers are discharge inflation chambers, each including the gas discharge portion. At least two of the gas discharge portions include a first gas discharge portion that starts discharging the inflation gas at a first timing and a second gas discharge portion that starts discharging the inflation gas at a second timing, which differs from the first timing. The first discharge portion is arranged in at least one of the independent inflation chambers.

In the above structure, at least one of the inflation chambers formed by dividing the airbag is the independent inflation chamber. Two or more of the inflation chambers including all the independent inflation chambers are the discharge inflation chambers. Each discharge inflation chamber is supplied with the inflation gas discharged from the corresponding gas discharge portion and then starts deploying and inflating. The first gas discharge portion, which is arranged in at least one of the independent inflation chambers, starts discharging the inflating gas at the first timing. The second gas discharge portion, which is arranged in the discharge inflation chamber that does not include the first gas inflation portion, starts discharging the inflating gas at the second timing, which differs from the first timing.

Accordingly, the discharge inflation chamber (including at least one independent inflation chamber) supplied with the inflating gas from the first gas discharge portion and the discharge inflation chamber supplied with the inflating gas from the second gas discharge portion start deploying and inflating at separate timings.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a side view showing, with an AM50 dummy, an automobile seat including a first embodiment of an airbag device applied to an automobile side airbag device;

FIG. 2 is a cross-sectional plan view showing the positional relationship of the automobile seat, an airbag, the AM50 dummy, and a side wall shown in FIG. 1;

FIG. 3 is a schematic cross-sectional side view showing, with the AM50 dummy and the automobile seat, the internal structure of an airbag module in which the airbag of FIG. 1 is in a non-inflated deployed state;

FIG. 4 is a partial cross-sectional plan view showing the internal structure of a side portion of a seat back incorporating the airbag module of FIG. 1;

FIG. 5A is a plan view showing the airbag of FIG. 1 in a state in which a top wall is tensioned and a pressure-regulating valve is closed;

FIG. 5B is an enlarged partial plan view showing FIG. 5A;

FIGS. 6A to 6C are schematic cross-sectional side views showing the operation of the pressure-regulating valve of FIG. 5;

FIG. 7 is a partial cross-sectional plan view corresponding to FIG. 4 and showing a state in which the airbag pops out from the automobile seat and deploys and inflates with part of the airbag left in the seat back;

FIG. 8 is a schematic partial cross-sectional side view showing a second embodiment of an airbag device applied to the automobile side airbag device and showing, with the AM50 dummy and the automobile seat, the internal structure of the airbag module in which the airbag is in the non-inflated deployed state;

FIG. 9 is a plan view showing the top wall removed from the airbag in a third embodiment of an airbag device applied to an automobile side airbag device;

FIG. 10 is a cross-sectional view taken along line 10-10 in FIG. 9;

FIG. 11A is a partial plan view showing a holding portion and its surrounding portion in a fourth embodiment of an airbag device applied to an automobile side airbag device;

FIG. 11B is a cross-sectional view taken along line 11b-11b in FIG. 11A;

FIG. 12 is a schematic cross-sectional side view showing a holding portion and its surrounding portion in a fifth embodiment of an airbag device applied to an automobile side airbag device;

FIG. 13 is a schematic cross-sectional side view showing a holding portion and its surrounding portion in a sixth embodiment of an airbag device applied to an automobile side airbag device; and

FIG. 14 is a partial plan view showing a holding portion of a modified example of the first embodiment and its surrounding portion.

### DETAILED DESCRIPTION OF THE PREFERRED EMBODIMENTS

### First Embodiment

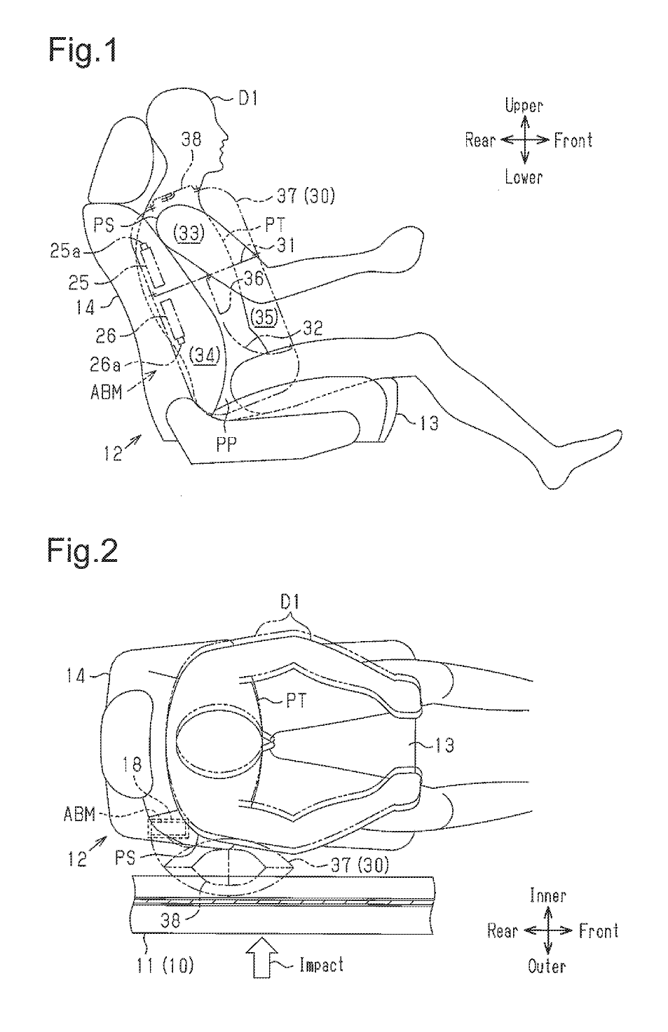

A first embodiment of an airbag device applied to an automobile side airbag device will now be described with reference to FIGS. 1 to 7.

In the following description, the front is the direction in which an automobile moves forward, and the rear is the direction in which the automobile moves rearward. Using the middle portion of the automobile in the widthwise direction (vehicle widthwise direction) as a frame of reference, the portion of a member closer to the middle portion will be referred to as the “vehicle inner side,” and the portion of a member farther from the middle portion will be referred to as the “vehicle outer side.” In addition, an AM50 dummy (model corresponding to 50% of American adult males) of World Side Impact Dummy (WorldSID) is seated on an automobile seat in a correct posture.

As shown in FIGS. 1 and 2, an automobile seat 12 serving as a vehicle seat is mounted in the proximity of a side wall 11 of the automobile 10, which serves as a vehicle, at the vehicle inner side of the side wall 11. The side wall 11 refers to an automobile component located on the side of the automobile 10 and mainly corresponds to a door, a pillar, or the like. For example, the side wall 11 corresponding to a front seat is a front door, a center pillar (B pillar), or the like. The side wall 11 corresponding to a rear seat is a rear portion of a side door (rear door), a C pillar, a front portion of a wheel well, a rear quarter panel, or the like.

The automobile seat 12 includes a seat cushion 13 and a seat back 14 that extends upright from a rear side of the seat cushion 13 toward the diagonally rear upper side. The automobile seat 12 is arranged in the automobile 10 with the seat back 14 directed toward the front. The widthwise direction of the automobile seat 12 installed in this manner coincides with the vehicle widthwise direction.

The internal structure of a side portion of the seat back 14 located at the vehicle outer side will now be described.

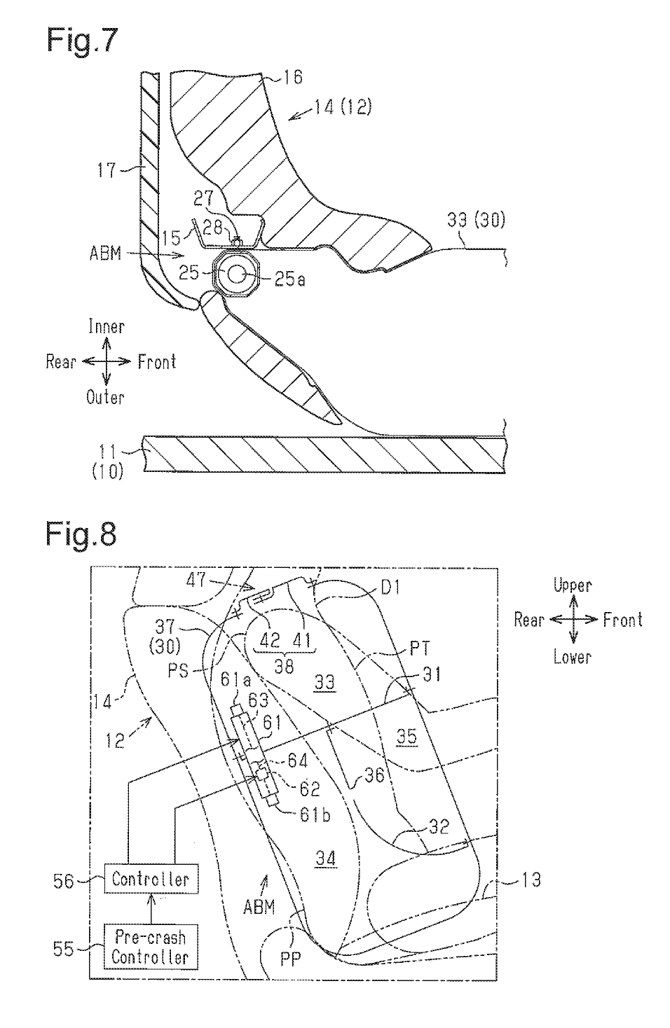

A seat frame that forms the framework of the seat back 14 is arranged in the seat back 14. As shown in FIG. 4, a portion of the seat frame is located at the vehicle outer side in the seat back 14. This portion (hereinafter referred to as “side frame 15”) is formed by, for example, bending a metal plate. A seat pad 16, which is formed from an elastic material such as urethane foam, is arranged at a front side of the seat frame including the side frame 15. Further, a hard back board 17, which is formed from synthetic resin or the like, is arranged at a rear side of the seat frame. The seat pad 16 is covered with upholstery. However, the upholstery is not shown in FIGS. 4 and 7 (described later).

In the seat pad 16, an accommodation portion 18 is arranged in the proximity of the vehicle outer side of the side frame 15. An airbag module ABM, which serves as a main unit of the side airbag device, is incorporated in the accommodation portion 18.

A slit 19 extends from a front corner of the accommodation portion 18 toward the diagonally front side and toward the outside of the automobile. A portion held between a front corner 16c of the seat pad 16 and the slit 19 (portion encircled by chain line in FIG. 4) is a tearing expected portion 21 torn by a side airbag (hereinafter referred to as “airbag 30”), which will be described later.

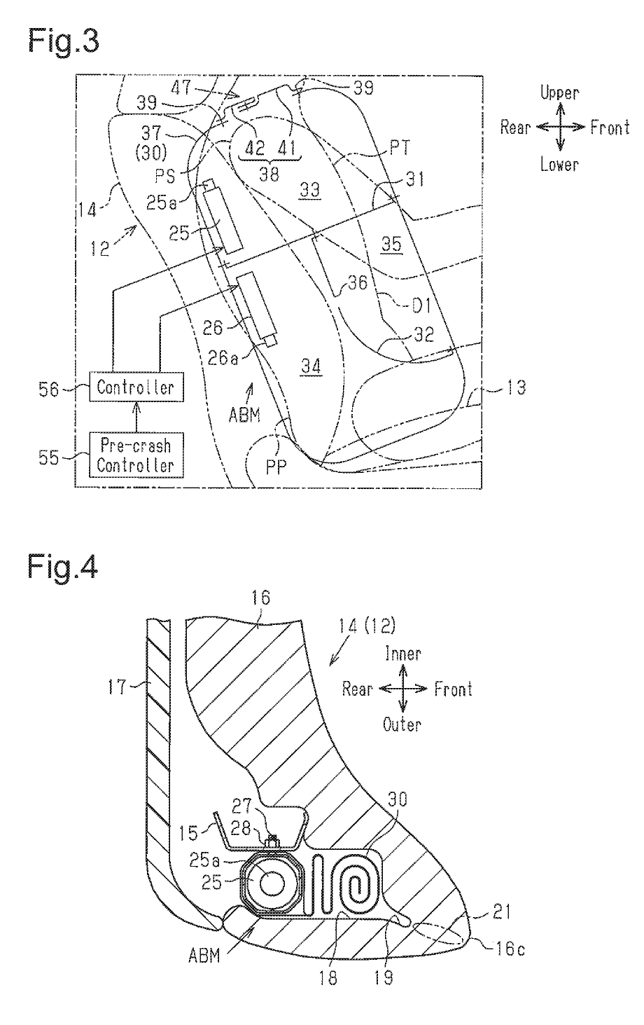

As shown in FIGS. 3 and 4, main components of the airbag module ABM include two gas discharge devices 25 and 26 and the airbag 30. Each of these components will now be described.

Gas Discharge Devices 25, 26

The gas discharge device 25 accommodates a gas generator (not shown) that generates inflation gas. The gas discharge device 25 is elongated in the vertical direction. A gas discharge portion 25a, which discharges inflation gas generated in the gas discharge device 25, is arranged at an upper end of the gas discharge device 25.

In the same manner, the gas discharge device 26 accommodates a gas generator (not shown) that generates inflation gas. The gas discharge device 26 is elongated in the vertical direction. A gas discharge portion 26a, which discharges inflation gas generated in the gas discharge device 26, is arranged at a lower end of the gas discharge device 26.

Instead of a pyro type that uses a gas generator, the gas discharge devices 25 and 26 may be of a type (hybrid type) that discharges inflation gas by tearing a partition wall of a high-pressure gas tank, which is filled with high-pressure gas, with an explosive or the like.

A bolt 27 is fixed to each of the gas discharge devices 25 and 26 as an engagement member that couples the gas discharge devices 25 and 26 to the side frame 15.

Airbag 30

FIG. 3 shows the internal structure of the airbag module ABM in a state in which the airbag 30 is deployed in a planar state without being filled with inflation gas (hereinafter referred to as “non-inflated deployed state”).

The airbag 30 is formed by folding a single fabric piece (also referred to as ground fabric, panel fabric, or the like) in half, overlapping the folded fabric pieces in the vehicle widthwise direction, and coupling the peripheral portions of the fabric. The airbag 30 is shaped and sized to occupy regions located beside many parts of the upper body (section from waist PP to shoulder PS) of the AM50 dummy (hereinafter referred to as “dummy D1”) in the space between the automobile seat 12 and the side wall 11 when the airbag 30 deploys and inflates in the space (refer to FIG. 1).

A flexible material that has high strength and is easy to fold is used as the fabric piece. Woven fabric or the like formed by, for example, polyester yarn or polyamide yarn is suitable for such a material.

The airbag 30 includes a horizontal partition 31 and a vertical partition 32 that are defined by a fabric piece formed from the same material as the airbag 30. The horizontal partition 31 and the vertical partition 32 have the same structure as a tether.

The horizontal partition 31 extends in the front-to-rear direction at a portion closer to the upper portion of the airbag 30. The horizontal partition 31 divides the airbag 30 into an upper inflation chamber 33 located at the upper side of the horizontal partition 31 and a lower inflation chamber located at the lower side of the horizontal partition 31.

The vertical partition 32 is arranged in the lower inflation chamber. An upper portion of the vertical partition 32 extends in the vertical direction, and a lower portion of the vertical partition 32 is curved to bulge toward the diagonally rear side. The vertical partition 32 divides the lower inflation chamber into a rear lower inflation chamber 34 located at the rear side of the vertical partition 32 and a front lower inflation chamber 35 located at the front side of the vertical partition 32.

In this manner, the horizontal partition 31 and the vertical partition 32 divide the airbag 30 into three inflation chambers, namely, the upper inflation chamber 33, the rear lower inflation chamber 34, and the front lower inflation chamber 35. Among the three chambers, the upper inflation chamber 33 is an independent inflation chamber. Thus, gas does not flow to and from the upper inflation chamber 33 and the two adjacent chambers, namely, the rear lower inflation chamber 34 and the front lower inflation chamber 35.

The upper inflation chamber 33 is deployed and inflated beside the shoulder PS to protect the shoulder PS of the upper body of the dummy D1 from an impact. The rear lower inflation chamber 34 is deployed and inflated beside the rear half of the chest PT and beside the waist PP to protect the side of the rear half of the chest PT and the side of the waist PP of the upper body of the dummy D1 from an impact. The front lower inflation chamber 35 is deployed and inflated beside the front half of the chest PT to protect the front half of the chest PT of the upper body of the dummy D1 from an impact.

The vertical partition 32 includes a communication portion 36 through which the rear lower inflation chamber 34 and the front lower inflation chamber 35 are in communication. In the first embodiment, the communication portion 36 is a hole extending through the vertical partition 32. The communication portion 36 allows inflation gas to flow to and from the rear lower inflation chamber 34 and the front lower inflation chamber 35. Thus, the rear lower inflation chamber 34 and the front lower inflation chamber 35 are non-independent inflation chambers, which differ from the upper inflation chamber 33.

Among the three inflation chambers, the upper inflation chamber 33 that is an independent inflation chamber serves as a discharge inflation chamber including the gas discharge portion 25a, and the rear lower inflation chamber 34 that is a non-independent inflation chamber serves as a discharge inflation chamber including the gas discharge portion 26a.

At a rear portion of the upper inflation chamber 33, the gas discharge device 25 extends in the vertical direction, and the bolt 27 extends toward the middle of the automobile. The bolt 27 is inserted through a wall of the upper inflation chamber 33 located at the vehicle inner side. The gas discharge portion 25a of the gas discharge device 25 defines a first gas discharge portion that starts discharging inflation gas at a first timing.

At a rear portion of the rear lower inflation chamber 34, the gas discharge device 26 extends in the vertical direction, and the bolt 27 extends toward the middle of the automobile. The bolt 27 is inserted through a wall of the rear lower inflation chamber 34 located at the vehicle inner side. The gas discharge portion 26a of the gas discharge device 26 defines a second gas discharge portion that starts discharging inflation gas at a second timing, which is delayed from the first timing.

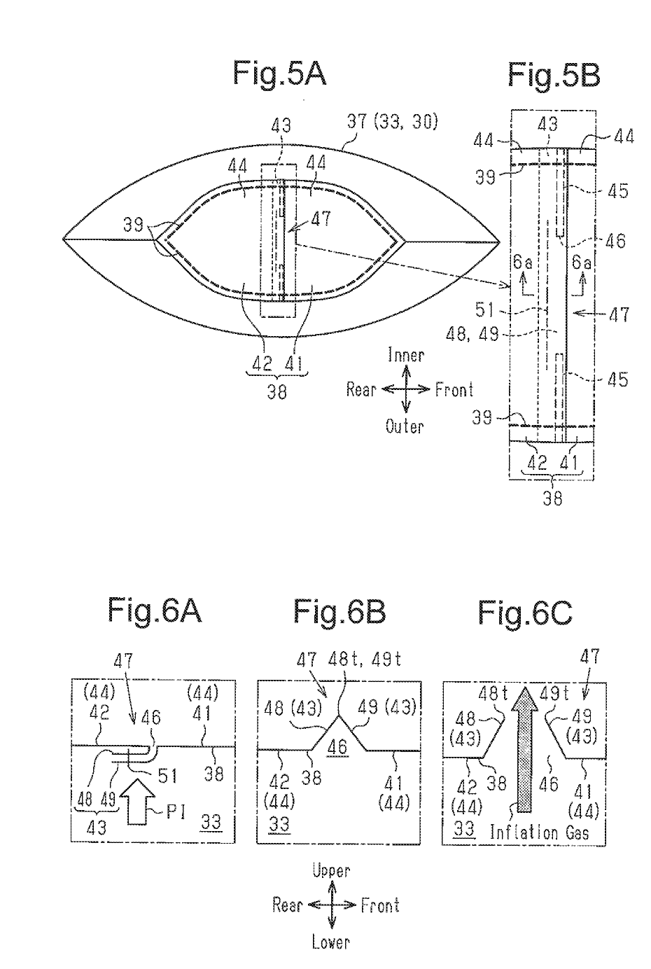

As shown in FIGS. 3 and 5A, the upper inflation chamber 33 includes a body wall 37 that forms most of the upper inflation chamber 33 and a top wall 38 that forms the top of the upper inflation chamber 33. When the deployment and inflation of the upper inflation chamber 33 tensions the top wall 38 in a planar manner, the top wall 38 is shaped so that the dimension in the front-to-rear direction is greater than that in the vehicle widthwise direction.

The edge of the top wall 38 is coupled to an edge of the upper end of the body wall 37 by an edge coupling portion 39. The edge coupling portion 39 is formed by sewing (with sewing yarn) the edge of the top wall 38 to the edge of the upper end of the body wall 37. Two coupling portions 45 and a tear seam 51, which will be described later, are formed in the same manner.

Sewn portions formed by the sewing are shown by two types of lines in FIGS. 5A, 5B, 9, 11A, and 14. The first type of line includes non-continuous bold lines that have a constant length. The first type of line indicates that the sewn portion is viewed from above (refer to edge coupling portions 39 in FIG. 5A). The second type of line includes non-continuous fine lines that have a constant length and are longer than broken lines, which serve as hidden lines. The second type of line indicates the state of a sewing yarn located toward the inner side (lower side) of a non-overlapping portion 44 (described later) and is not directly visible (hidden) (refer to coupling portion 45 and the like in FIG. 5B).

The top wall 38 is formed by two pieces of fabric arranged in the front-to-rear direction. In order to distinguish the two pieces of fabric, the fabric located at the front side is referred to as the front fabric 41, and the fabric located at the rear side is referred to as the rear fabric 42.

As shown in FIGS. 5B and 6A, the front fabric 41 and the rear fabric 42 include two overlapping portions 43, at which the front and rear fabrics 41 and 42 overlap each other in a belt-like manner, and the non-overlapping portions 44, which exclude the overlapping portions 43. The front fabric 41 and the rear fabric 42 are coupled to each other by the coupling portions 45 extending in the vehicle widthwise direction at boundaries of the two overlapping portions 43 and the two non-overlapping portions 44.

An opening 46 and a pressure-regulating valve 47 are arranged in the middle of the top wall 38, which is a portion of the upper inflation chamber 33 that is not adjacent to the rear lower inflation chamber 34 and the front lower inflation chamber 35, in the front-to-rear direction and the vehicle widthwise direction. The opening 46 and the pressure-regulating valve 47 will now be described.

When the top wall 38 is tensioned, the coupling portions 45 uncouple the middle of the top wall 38 in the vehicle widthwise direction. In other words, when the top wall 38 is tensioned, the coupling portions 45 that couple the front fabric 41 and the rear fabric 42 are not arranged at the middle of the top wall 38 in the vehicle widthwise direction at the boundaries of the two overlapping portions 43 and the two non-overlapping portions 44. The portion that does not include the coupling portions 45, that is, the uncoupled portion, forms the opening 46, which is slit-shaped and extends in the vehicle widthwise direction. The opening 46 allows for communication between the inner side and the outer side of the upper inflation chamber 33.

Before the upper inflation chamber 33 restrains the shoulder PS, the pressure-regulating valve 47 closes and restricts the flow of inflation gas from the upper inflation chamber 33 through the opening 46 to the outside of the airbag 30. When the upper inflation chamber 33 restrains the shoulder PS, the pressure-regulating valve 47 opens and permits the outward flow of inflation gas in accordance with a change in the tensioned state of the top wall 38 resulting from an external force produced by the restraint. The pressure-regulating valve 47 includes two valve bodies 48 and 49 located at the overlapping portions 43 and portions corresponding to the opening 46 (proximate portion).

Further, the pressure-regulating valve 47 includes a holding portion that keeps the pressure-regulating valve 47 closed until a certain time during a period in which the upper inflation chamber 33 restrains the shoulder PS. The holding portion then releases the pressure-regulating valve 47. In the first embodiment, the holding portion is the tear seam 51 that couples the two valve bodies 48 and 49 that are in contact with and proximate to each other and is torn subsequent to the certain time of the restraint period.

When the top wall 38 is tensioned, the tear seam 51 extends in the vehicle widthwise direction at the middle of the overlapping portion 43 in the vehicle widthwise direction. Most of the tear seam 51 in the vehicle widthwise direction is located in the two valve bodies 48 and 49, and the two sides of the tear seam 51 in the vehicle widthwise direction overlap the coupling portions 45. The tear seam 51 couples the two valve bodies 48 and 49 with a lower strength than other coupling portions, for example, the edge coupling portions 39 and the coupling portions 45. This tears the tear seam 51 more easily than the other coupling portions. The tear seam 51 is formed by sewing the two overlapping portions 43 with a sewing yarn.

The two overlapping portions 43 are bent toward the front or rear (rear in the first embodiment) to overlap the non-overlapping portions 44 at the boundaries with the non-overlapping portions 44. Further, the two bent belt-shaped overlapping portions 43 are sewn together and coupled to the top wall 38 and the body wall 37 by the edge coupling portions 39 at the two ends of the overlapping portions in the vehicle widthwise direction.

As shown in FIG. 4, the airbag module ABM has a compact form (hereinafter referred to as “accommodation form”) in the front-to-rear direction and the vertical direction by folding the airbag 30 in the non-inflated deployed state through roll folding, accordion-like folding, or the like. In the roll folding, other portions are wound around one of the two ends of the airbag 30. In the accordion-like folding, the airbag 30 is folded back and forth over a certain width in opposite directions. When the airbag 30 is in the accommodation form, the airbag module ABM is sized and shaped in a manner suitable for accommodation in the accommodation portion 18 of the seat back 14 where space is limited. The airbag module ABM in which the airbag 30 is folded is maintained at the accommodation form by a holding means such as a binding tape (not shown).

The airbag module ABM in the accommodation form is accommodated in the accommodation portion 18 with the gas discharge devices 25 and 26 located at the rear side and most of the airbag 30 located at the front side. As described above, the bolt 27 extended from each of the gas discharge devices 25 and 26 and inserted through a wall of each of the upper inflation chamber 33 and the rear lower inflation chamber 34 located at the vehicle inner side is inserted through the side frame 15 from the vehicle outer side of the side frame 15. Nuts 28 are fastened to the bolts 27 from the vehicle inner sides of the bolts 27. The fastening of the nuts 28 fixes the two gas discharge devices 25 and 26 to the side frame 15 together with the airbag 30.

Each of the gas discharge devices 25 and 26 may be fixed to the side frame 15 by a member that differs from the bolt 27 and the nut 28.

Further, as shown in FIG. 3, the automobile 10 includes a pre-crash controller 55. The pre-crash controller 55 recognizes a preceding vehicle, an oncoming vehicle, a road obstacle, or the like in front of the automobile based on a detection signal such as millimeter wave. Then, the pre-crash controller 55 calculates the speed, distance, and the like of such subjects relative to the automobile 10. When the pre-crash controller 55 determines that a collision is likely to occur based on the calculation result, that is, predicts a collision, the pre-crash controller 55 outputs the information as a pre-crash signal.

Based on the pre-crash signal, a separate controller or the like performs, for example, control that notifies an occupant of the possibility of a collision by activating a lamp, a buzzer, or the like, control that prompts a brake operation and assists a braking force at an early stage in accordance with brake pedaling, and control that winds a seatbelt with an electric motor. Such controls allow a safety device of an automobile to be activated at an early stage.

In addition to the airbag module ABM, the side airbag device includes a controller 56 connected to the pre-crash controller 55. The controller 56 controls activation of the two gas discharge devices 25 and 26 in response to the pre-crash signal.

Further, the automobile 10 includes a seatbelt device that restrains the dummy D1, which is seated on the automobile seat 12, to the automobile seat 12. The seatbelt device is not shown in FIG. 3 and the like.

The side airbag device of the first embodiment has the structure described as above. The typical operation (modes) will now be described as the effects and advantages of the side airbag device. FIGS. 6A to 6C schematically show that after the supply of inflation gas starts, the shapes of the pressure-regulating valve 47 and the like change as time elapses. The detail of the pressure-regulating valve 47 and the like is omitted and simplified.

Referring to FIGS. 3 and 4, in the side airbag device, when the pre-crash controller 55 does not output a pre-crash signal, that is, when the pre-crash controller 55 does not predict a side collision, the controller 56 does not provide the gas discharge devices 25 and 26 with activation signals that activate the gas discharge devices 25 and 26. The gas discharge portions 25a and 26a of the gas discharge devices 25 and 26 do not discharge inflation gas. The airbag 30 remains accommodated in the accommodation portion 18 in the same accommodation form together with the gas discharge devices 25 and 26. In the pressure-regulating valve 47, the two valve bodies 48 and 49 overlap each other in the upper inflation chamber 33 to close the pressure-regulating valve 47. The tear seam 51 maintains the coupling of the two valve bodies 48 and 49.

If another automobile approaches from beside and is likely to collide with the automobile 10 when the automobile 10 is traveling, the pre-crash controller 55 outputs a pre-crash signal. The controller 56 receiving the pre-crash signal provides the gas discharge device 25 of the upper inflation chamber 33, which is an independent inflation chamber, with an activation signal that activates the gas discharge device 25. In response to the activation signal, the gas discharge portion 25a starts discharging inflation gas at the first timing.

The inflation gas increases the internal pressure of the upper inflation chamber 33. This causes the inflation chamber 33 to start deploying and inflating beside the shoulder PS before a collision occurs. The deploying and inflating upper inflation chamber 33 pulls the top wall 38 in the planar direction before the shoulder PS of the dummy D1 is pressed toward the middle of the automobile (before shoulder PS is restrained), that is, at the beginning of the deployment and inflation of the upper inflation chamber 33. Tension is applied to the top wall 38 in the front-to-rear direction and the vehicle widthwise direction to tension the top wall 38.

As shown in FIG. 6A, internal pressure PI is applied to the two valve bodies 48 and 49, which are located in the upper inflation chamber 33, from below in the overlapping (thickness-wise) direction of the two valve bodies 48 and 49. The internal pressure PI causes the two valve bodies 48 and 49 to contact each other throughout their surfaces so that the valve bodies 48 and 49 are in a self-sealed state that restricts the flow of inflation gas between the two valve bodies 48 and 49. Further, the overlapping portions 43 that are bent to overlap the non-overlapping portions 44 of the top wall 38 are pressed by the internal pressure PI to the non-overlapping portions 44. This further facilitates the closing of the two valve bodies 48 and 49.

The top wall 38 is longer in the front-to-rear direction than in the vehicle widthwise direction. Thus, stronger tension is easily applied to the top wall 38 in the vehicle widthwise direction than in the front-to-rear direction. The opening 46 extends in the vehicle widthwise direction where strong tension is easily applied. Thus, the opening 46 is easily closed.

However, although tension acts as described above, the tension applied in the front-to-rear direction also acts to open the top wall 38. Thus, the top wall 38 does not necessarily close and may open. Nevertheless, even in this case, the two valve bodies 48 and 49 are closed at least at distal ends 48t and 49t of the two valve bodies 48 and 49. This is because even when the top wall 38 is tensioned and pulled in the front-to-rear direction, force that acts to open the top wall 38 is applied to the top wall 38. The force is maximal in the proximity of the edge coupling portions 39. The force decreases as the edge coupling portions 39 becomes farther, and the force is minimal at the distal ends 48t and 49t of the two valve bodies 48 and 49.

Further, in the first embodiment, the overlapping portions 43 bent toward the non-overlapping portions 44 are coupled to the edge of the upper end of the body wall 37 by the edge coupling portions 39 at the two ends of the overlapping portions 43 in the vehicle widthwise direction in which the coupling portions 45 extend. Thus, when the upper inflation chamber 33 is deployed and inflated, strong tension is applied to the overlapping portions 43 in the vehicle widthwise direction in addition to the non-overlapping portions 44 in the vehicle widthwise direction.

When the two valve bodies 48 and 49 at least partially contact each other, the pressure-regulating valve 47 is closed. This restricts the flow of inflation gas from the upper inflation chamber 33 through the two valve bodies 48 and 49 (opening 46) to the outside of the airbag 30. As a result, the inflation gas is accumulated in the upper inflation chamber 33 to increase the internal pressure of the upper inflation chamber 33.

The increase in the internal pressure acts to unfold (deploy) the upper inflation chamber 33 in an order opposite to the order in which the upper inflation chamber 33 is folded. The seat pad 16 of the seat back 14 is pressed by the upper inflation chamber 33 and torn at the tearing expected portion 21 (refer to FIG. 4). As shown in FIG. 7, the upper inflation chamber 33 pops out toward the front from the seat back 14 through the torn portion with part of the upper inflation chamber 33 left in the accommodation portion 18.

Subsequently, the upper inflation chamber 33 supplied with inflation gas unfolds and deploys toward the front in a gap between the side wall 11 and the shoulder PS, which is the narrowest portion of the gap between the dummy D1 and the side wall 11, as shown by the dashed line in FIG. 2.

As the deployment and inflation of the upper inflation chamber 33 continue, the upper inflation chamber 33 presses the shoulder PS of the dummy D1 toward the middle of the automobile to restrain the shoulder PS. This moves the dummy D1 toward the middle of the automobile before a collision occurs and expands the space between the dummy D1 and the side wall 11.

The shoulder PS is pressed by the upper inflation chamber 33 not only after but also before the seat pad 16 is torn. Before the seat pad 16 is torn, the upper inflation chamber 33 that deploys and inflates in the seat back 14 presses and inflates the proximate portion of the upper inflation chamber 33 of the seat pad 16 toward the diagonally upper side and toward the middle of the automobile. The inflated portion presses the shoulder PS of the dummy D1 leaning on the seat back 14. In this manner, the seat pad 16 indirectly presses the shoulder PS. After the seat pad 16 is torn, the shoulder PS is directly pressed toward the middle of the automobile by the upper inflation chamber 33 that deploys and inflates toward the front.

Further, as shown in FIG. 6A, when the upper inflation chamber 33 restrains the dummy D1, in a state in which the entire surfaces of the two valve bodies 48 and 49 are in close contact (closed) with each other, the upper inflation chamber 33 continues to be supplied with inflation gas, and an external force applied from the side wall 11 cause the pressure-regulating valve 47 to start opening.

More specifically, subsequent to a certain time during the period in which the inflation gas is supplied to the upper inflation chamber 33, the restraint of the shoulder PS applies an external force that presses and deforms the upper inflation chamber 33. This decreases the tension that has been strongly applied to the top wall 38 in the vehicle widthwise direction. As a result, the difference decreases between the tension applied in the front-to-rear direction and that in the vehicle widthwise direction.

Further, the deformation of the upper inflation chamber 33 further increases the internal pressure. This presses the top wall 38 toward the outer side (upper side) and changes the tension applied to the top wall 38. The change also decreases the difference between the tension applied in the front-to-rear direction and that in the vehicle widthwise direction. This allows deformation of the top wall 38 and activation of the valve bodies 48 and 49.

The overlapping portions 43 are overlapped with the non-overlapping portion 44 and coupled to the body wall 37 by the edge coupling portions 39 at the two ends of the overlapping portions 43 in the vehicle widthwise direction. Thus, the force that acts to maintain the overlapped state is strong at portions of the overlapping portions 43 that are proximate to the edge coupling portions 39. However, the force decreases as the edge coupling portions 39 becomes farther, and the force is minimal at the middle in the vehicle widthwise direction, that is, at the two valve bodies 48 and 49. Thus, the overlapping portions 43 pulled in the front-to-rear direction are deformed in the front-to-rear direction only at the two valve bodies 48 and 49 and portions proximate to the two valve bodies 48 and 49.

In the overlapping portions 43, when the pressure-regulating valve 47 opens for a certain amount, only the two valve bodies 48 and 49 that receive high internal pressure PI from the upper inflation chamber 33 are forced (inverted) out of the airbag 30 through the opening 46.

Immediately after the two valve bodies 48 and 49 are inverted as described above, the distal ends 48t and 49t contact each other to close the two valve bodies 48 and 49 (refer to FIG. 6B). When the distal ends 48t and 49t are separated from each other (refer to FIG. 6C) to open the pressure-regulating valve 47, the outward flow of the inflation gas is permitted. This allows the inflation gas to flow from the upper inflation chamber 33 sequentially through the opening 46 and through the space between the two valve bodies 48 and 49 to the outside.

As described above, when the upper inflation chamber 33 restrains the shoulder PS, the pressure-regulating valve 47 opens. In the first embodiment, the opening period is changed by the tear seam 51 to be delayed from the opening period during which only using the pressure-regulating valve 47.

More specifically, during a period before the upper inflation chamber 33 restrains the shoulder PS of the dummy D1 and a period from the beginning of the restraint period to a certain time of the restraint period, the force that acts to separate the two valve bodies 48 and 49 is overcome by the force of the tear seam 51 that acts to couple the two valve bodies 48 and 49, in other words, the force that acts to keep the two valve bodies 48 and 49 in contact with each other. This restricts the tearing of the tear seam 51 and maintains the coupling by the tear seam 51. Further, this keeps the two valve bodies 48 and 49 in contact with each other and keeps the pressure-regulating valve 47 closed.

Subsequent to the certain time of the period during which the upper inflation chamber 33 restrains the dummy D1, the force that acts to separate the two valve bodies 48 and 49 overcomes the force of the tear seam 51 that acts to couple the two valve bodies 48 and 49. This tears the tear seam 51, uncouples the two valve bodies 48 and 49 that have been coupled (held) by the tear seam 51, and eliminates the force that acts to keep the two valve bodies 48 and 49 in contact with each other. This allows for the separation of the two valve bodies 48 and 49 from each other (opening of pressure-regulating valve 47).

Thus, within the restraint period, the opening period of the pressure-regulating valve 47 is delayed by the period during which the tear seam 51 keeps the two valve bodies 48 and 49 in contact with each other. This delays the timing when the inflation gas starts flowing from the upper inflation chamber 33 through the opening 46 to the outside of the airbag 30.

The outward flow of the inflation gas changes the internal pressure of the upper inflation chamber 33 from increases to decreases. However, the side wall 11 still continues to move toward the middle of the automobile, and the upper inflation chamber 33 is pressed by the shoulder PS.

As shown in FIG. 3, the discharge of inflation gas starts in the rear lower inflation chamber 34 from the gas discharge portion 26a at a second timing, which is delayed from the first timing. The inflation gas starts to deploy and inflate the rear lower inflation chamber 34 beside the second half of the chest PT of the dummy D1 and beside the waist PP of the dummy D1. Some of the inflation gas discharged to the rear lower inflation chamber 34 flows into the front lower inflation chamber 35 through the communication portion 36 of the vertical partition 32. The inflation gas causes the front lower inflation chamber 35 to start deploying and inflating at a timing later than that of the rear lower inflation chamber 34.

When a single chamber forms a lower inflation chamber, the lower inflation chamber suddenly deploys and inflates toward the front at once. In this regard, the lower inflation chamber of the first embodiment is divided into the rear lower inflation chamber 34 and the front lower inflation chamber 35. The rear lower inflation chamber 34 first starts deploying and inflating, and then the front lower inflation chamber 35 starts deploying and inflating. Thus, even when an obstacle exists in front of a lower inflation chamber before the lower inflation chamber deploys and inflates, the obstacle is not strongly pressed.

As described above, the space between the dummy D1 and the side wall 11 is expanded by the upper inflation chamber 33. Thus, the rear lower inflation chamber 34 and the front lower inflation chamber 35 easily deploy and inflate between the side wall 11 and the portions of the dummy D1 located below the shoulder PS (chest PT and waist PP).

As a result, the deployed and inflated airbag 30 can easily be positioned between the dummy D1 and the side wall 11 that moves toward the middle of the automobile together with the dummy D1 to restrain the dummy D1 and buffer the impact transmitted from beside to the dummy D1 through the side wall 11. This is the original advantage of a side airbag device.

The advantage can be obtained in the same manner when an occupant who has a body frame similar to the dummy D1 is seated on the automobile seat 12 in a correct posture.

### Second Embodiment

A second embodiment of an airbag device applied to an automobile side airbag device will now be descried with reference to FIG. 8.

In the second embodiment, a gas discharge device 61 common to all the gas discharge portions is used as a gas charge device. A first gas discharge portion 61a is arranged at an upper end of the gas discharge device 61, and a second gas discharge portion 61b is arranged at a lower end of the gas discharge device 61. The gas discharge device 61 includes a gas supply passage 63 that supplies the first gas discharge portion 61a with inflation gas and a gas supply passage 64 that supplies the second gas discharge portion 61b with inflation gas.

The gas discharge device 61 is inserted through the horizontal partition 31 and traverses the rear portion of the upper inflation chamber 33 and the rear portion of the rear lower inflation chamber 34. The first gas discharge portion 61a is located in the upper inflation chamber 33, and the second gas discharge portion 61b is located in the rear lower inflation chamber 34.

The gas supply passage 64, which supplies the second gas discharge portion 61b with inflation gas, includes an opening/closing valve 62 that opens and closes the gas supply passage 64. The controller 56 controls activation of the opening/closing valve 62. The opening/closing valve 62 closes when the controller 56 does not output a signal that opens the opening/closing valve 62, and the opening/closing valve 62 opens when the controller 56 outputs the signal.

The second embodiment has the same structure as the first embodiment other than the above. Thus, like or same reference numerals are given to those components that are the same as the corresponding components of the first embodiment. Such components will not be described in detail.

In the second embodiment, when the pre-crash controller 55 does not output a pre-crash signal, that is, when the pre-crash controller 55 does not predict a side collision, the controller 56 does not provide the gas discharge device 61 with an activation signal that activates the gas discharge device 61. Further, the controller 56 does not provide the opening/closing valve 62 with a signal that opens the opening/closing valve 62. Thus, the opening/closing valve 62 remains closed. Accordingly, the gas discharge device 61 does not generate inflation gas, and the first gas discharge portion 61a and the second gas discharge portion 61b do not discharge inflation gas. The airbag 30 remains accommodated in the accommodation portion 18 in the same accommodation form together with the gas discharge device 61 (refer to FIG. 4).

If another automobile approaches from beside and is likely to collide with the automobile 10 when the automobile 10 is traveling, the pre-crash controller 55 outputs a pre-crash signal. Then, the controller 56 provides the gas discharge device 61 with an activation signal that activates the gas discharge device 61. The gas discharge device 61 generates inflation gas, and the inflation gas is supplied to the two gas supply passages 63 and 64. The controller 56 does not provide the opening/closing valve 62 with a signal that opens the opening/closing valve 62. Thus, the opening/closing valve 62 remains closed. Accordingly, the first gas discharge portion 61a starts discharging the inflation gas at the first timing, but the second gas discharge portion 61b does not start discharging the inflation gas. The upper inflation chamber 33 starts deploying and inflating, but the rear lower inflation chamber 34 and the front lower inflation chamber 35 do not start deploying and inflating.

Thus, the deploying and inflating upper inflation chamber 33 presses the shoulder PS of the dummy D1 toward the middle of the automobile and moves the dummy Dl1 toward the middle of the automobile before a collision occurs. This expands the space between the dummy D1 and the side wall 11.

When a predetermined minute time has elapsed after the controller 56 outputs an activation signal to the gas discharge device 61, the controller 56 provides the opening/closing valve 62 with a signal that opens the opening/closing valve 62. When the opening/closing valve 62 opens in response to the signal, the second gas discharge portion 61b to which inflation gas is supplied through the gas supply passage 64 starts discharging the inflation gas at the second timing, which is delayed from the first timing. This causes the rear lower inflation chamber 34 to start deploying and inflating. Some of the inflation gas discharged to the rear lower inflation chamber 34 flows into the front lower inflation chamber 35 through the communication portion 36 of the vertical partition 32, and the front lower inflation chamber 35 starts deploying and inflating at a timing later than that of the rear lower inflation chamber 34.

As described above, the space between the dummy D1 and the side wall 11 is expanded by the upper inflation chamber 33. Thus, the rear lower inflation chamber 34 and the front lower inflation chamber 35 easily deploy and inflate between the side wall 11 and the portions of the dummy D1 located below the shoulder PS (chest PT and waist PP).

As a result, each of the inflation chambers of the deployed and inflated airbag 30 can easily be positioned between the dummy D1 and the side wall 11 that moves toward the middle of the automobile together with the dummy D1 to restrain the dummy D1 in the same manner as the first embodiment.

The opening 46, the pressure-regulating valve 47, and the tear seam 51 of the top wall 38 are activated in the same manner as the first embodiment and thus will not be described.

### Third Embodiment

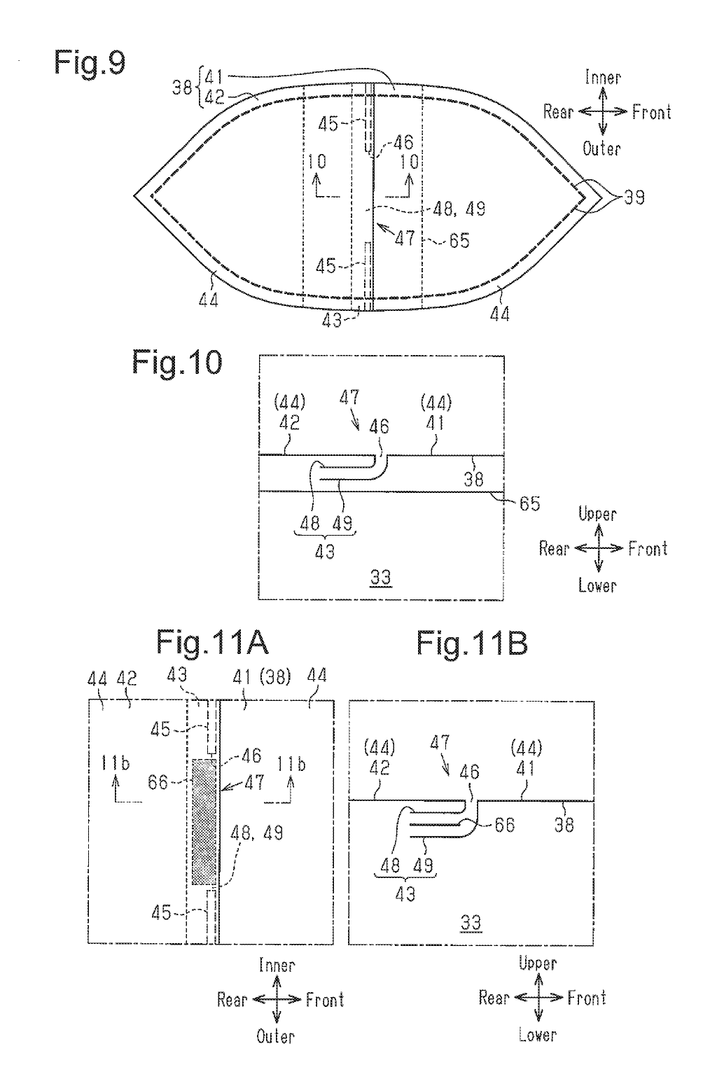

A third embodiment of an airbag device applied to an automobile side airbag device will now be descried with reference to FIGS. 9 and 10.

In the third embodiment, the holding portion is an auxiliary fabric 65 instead of the tear seam 51. The auxiliary fabric 65 is overlapped from below with the lower valve body 49 of the pressure-regulating valve 47 in the closed state. The auxiliary fabric 65 is longer in the vehicle widthwise direction than in the front-to-rear direction. The auxiliary fabric 65 is sewn together and coupled to the edge of the top wall 38 and the edge of the upper end of the body wall 37 by the edge coupling portions 39 at the two sides of the auxiliary fabric 65 in the vehicle widthwise direction. This coupling causes the auxiliary fabric 65 to traverse the upper inflation chamber 33.

The third embodiment has the same structure as the first embodiment other than the above. Thus, like or same reference numerals are given to those components that are the same as the corresponding components of the first embodiment. Such components will not be described in detail.

In the third embodiment, the auxiliary fabric 65 functions as a holding portion when deployment and inflation of the upper inflation chamber 33 tensions the auxiliary fabric 65. Further, the auxiliary fabric 65 acts to keep the two valve bodies 48 and 49 in contact with each other at the upper and lower positions between the auxiliary fabric 65 and two non-overlapping portions 44.

During a period before the upper inflation chamber 33 restrains the shoulder PS and a period from the beginning of the restraint period to a certain time of the restraint period, the force of the auxiliary fabric 65 that acts to keep the two valve bodies 48 and 49 in contact with each other is larger than the force that acts to separate the two valve bodies 48 and 49. Thus, the auxiliary fabric 65 keeps the two valve bodies 48 and 49 in contact with each other.

Subsequent to the certain time of the restraint period, the force that acts to separate the two valve bodies 48 and 49 overcomes the force of the auxiliary fabric 65 that acts to keep the two valve bodies 48 and 49 in contact with each other. This separates the two valve bodies 48 and 49 so that the two valve bodies 48 and 49 are no longer in contact with each other. Deformation of the auxiliary fabric 65 away from the lower valve body 49 allows for separation of the two valve bodies 48 and 49 (opening of pressure-regulating valve 47).

Thus, within the period during which the upper inflation chamber 33 restrains the shoulder PS, the opening period of the pressure-regulating valve 47 is delayed by the period during which the auxiliary fabric 65 keeps the two valve bodies 48 and 49 proximate to each other. This delays the timing when the inflation gas starts flowing from the upper inflation chamber 33 through the opening 46 to the outside of the airbag 30.

Accordingly, the same advantage as the first embodiment is obtained in the third embodiment, although the holding portion differs in shape.

### Fourth Embodiment

A fourth embodiment of an airbag device applied to an automobile side airbag device will now be descried with reference to FIGS. 11A and 11B.

In the fourth embodiment, the holding portion is, instead of the tear seam 51, an adhesive layer 66 formed between the two valve bodies 48 and 49 that are proximate to each other. The adhesive layer 66 couples the two valve bodies 48 and 49 and uncouple the two valve bodies 48 and 49 subsequent to a certain time of the period during which the upper inflation chamber 33 restrains the shoulder PS. The adhesive layer 66 couples (adheres) the two valve bodies 48 and 49 with a lower strength than other coupling portions, for example, the edge coupling portions 39 and the coupling portions 45. This tears the adhesive layer 66 more easily than the other coupling portions.

The fourth embodiment has the same structure as the first embodiment other than the above. Thus, like or same reference numerals are given to those components that are the same as the corresponding components of the first embodiment. Such components will not be described in detail.

In the fourth embodiment, the adhesive layer 66, which is formed between the two valve bodies 48 and 49 that are proximate to each other, acts to couple the two valve bodies 48 and 49 with an adhesive force.

During a period before the upper inflation chamber 33 restrains the shoulder PS and a period from the beginning of the restraint period to a certain time of the restraint period, the force (adhesive force) of the adhesive layer 66 that acts to couple the two valve bodies 48 and 49 is larger than the force that acts to separate the two valve bodies 48 and 49. This restricts tearing of the adhesive layer 66 and maintains the coupling by the adhesive layer 66.

Subsequent to the certain time of the restraint period, the force that acts to separate the two valve bodies 48 and 49 overcomes the force (adhesive force) of the adhesive layer 66 that acts to couple the two valve bodies 48 and 49. This tears the adhesive layer 66, uncouples the two valve bodies 48 and 49 that have been coupled (held) by the adhesive layer 66, and eliminates the force that acts to keep the two valve bodies 48 and 49 in contact with each other.

Thus, within the period during which the inflation chamber 33 restrains the shoulder PS, the opening period of the pressure-regulating valve 47 is delayed by the period during which the adhesive layer 66 keeps the two valve bodies 48 and 49 proximate to each other. This delays the timing when the inflation gas starts flowing from the upper inflation chamber 33 through the opening 46 to the outside of the airbag 30.

Accordingly, the same advantage as the first embodiment is obtained in the fourth embodiment, although the holding portion differs in shape.

### Fifth Embodiment

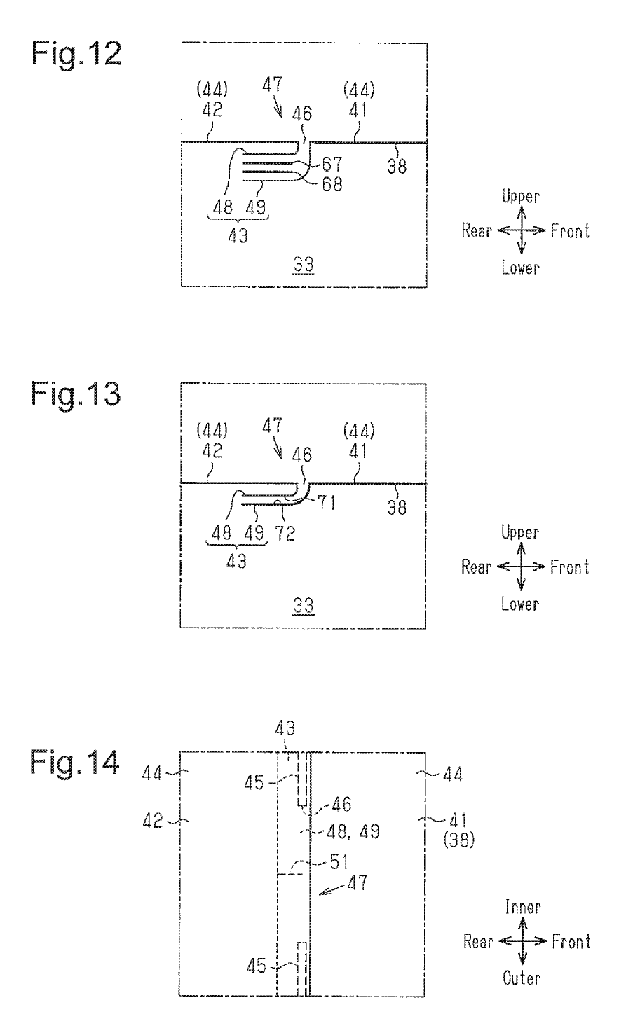

A fifth embodiment of an airbag device applied to an automobile side airbag device will now be descried with reference to FIG. 12.

In the fifth embodiment, the holding portion is, instead of the tear seam 51, a male fastener (hook fastener) 67 coupled to one of the two valve bodies 48 and 49 and a female fastener (loop fastener) 68 coupled to the other one of the two valve bodies 48 and 49 and bonded to the male fastener 67 in an engageable and removable manner.

The male fastener 67 and the female fastener 68 couple the two valve bodies 48 and 49 that are proximate to each other and uncouple the two valve bodies 48 and 49 subsequent to a certain time of the period during which the upper inflation chamber 33 restrains the shoulder PS. The male fastener 67 and the female fastener 68 couple the two valve bodies 48 and 49 with a lower strength than other coupling portions, for example, the edge coupling portions 39 and the coupling portions 45. This uncouples the two valve bodies 48 and 49 more easily than the other coupling portions.

The fifth embodiment has the same structure as the first embodiment other than the above. Thus, like or same reference numerals are given to those components that are the same as the corresponding components of the first embodiment. Such components will not be described in detail.

In the fifth embodiment, coupling of the male fastener 67 and the female fastener 68 couples the two valve bodies 48 and 49.

During a period before the upper inflation chamber 33 restrains the shoulder PS and a period from the beginning of the restraint period to a certain time of the restraint period, the force of the male fastener 67 and the female fastener 68 that acts to couple the two valve bodies 48 and 49 is larger than the force that acts to separate the two valve bodies 48 and 49. This restricts separation of the male fastener 67 and the female fastener 68 and maintains the coupling of the two valve bodies 48 and 49.

Subsequent to the certain time of the restraint period, the force that acts to separate the two valve bodies 48 and 49 overcomes the force of the male fastener 67 and the female fastener 68 that acts to couple the two valve bodies 48 and 49. This separates the male fastener 67 and the female fastener 68.

Thus, within the period during which the inflation chamber 33 restrains the shoulder PS, the opening period of the pressure-regulating valve 47 is delayed by the period during which the male fastener 67 and the female fastener 68 keep the two valve bodies 48 and 49 proximate to each other. This delays the timing when the inflation gas starts flowing from the upper inflation chamber 33 through the opening 46 to the outside of the airbag 30.

Accordingly, the same advantage as the first embodiment is obtained in the fifth embodiment, although the holding portion differs in shape.

### Sixth Embodiment

A sixth embodiment of an airbag device applied to an automobile side airbag device will now be descried with reference to FIG. 13.

In the sixth embodiment, the holding portion is, instead of the tear seam 51, a first friction portion 71 and a second friction portion 72. The first friction portion 71 is formed in at least part of the valve body 48. The second friction portion 72 is formed in at least part of the valve body 49 under the condition that the second friction portion 72 opposes the first friction portion 71. The second friction portion 72 generates a friction force by contacting the first friction portion 71 when the pressure-regulating valve 47 is closed. In the sixth embodiment, each of the entire front fabric 41 and the entire rear fabric 42 of the top wall 38 is formed from a material having a high coefficient of friction such as rubber or elastomer. The surface of the valve body 48 opposing the valve body 49 is the first friction portion 71, and the surface of the valve body 49 opposing the valve body 48 is the second friction portion 72.

The sixth embodiment has the same structure as the first embodiment other than the above. Thus, like or same reference numerals are given to those components that are the same as the corresponding components of the first embodiment. Such components will not be described in detail.

In the sixth embodiment, the first friction portion 71 formed in the valve body 48 and the second friction portion 72 formed in the valve body 49 contact each other to act to keep the two valve bodies 48 and 49 in contact with each other.

During a period before the upper inflation chamber 33 restrains the shoulder PS and a period from the beginning of the restraint period to a certain time of the restraint period, the force of the first friction portion 71 and the second friction portion 72 that acts to keep the two valve bodies 48 and 49 in contact with each other is larger than the force that acts to separate the two valve bodies 48 and 49. This restricts separation of the first friction portion 71 and the second friction portion 72 and keeps the two valve bodies 48 and 49 in contact with each other.

Subsequent to the certain time of the restraint period, the force that acts to separate the two valve bodies 48 and 49 overcomes the force of the first friction portion 71 and the second friction portion 72 that acts to keep the two valve bodies 48 and 49 in contact with each other. This separates the first friction portion 71 and the second friction portion 72.

Thus, within the period during which the inflation chamber 33 restrains the shoulder PS, the opening period of the pressure-regulating valve 47 is delayed by the period during which the first friction portion 71 and the second friction portion 72 keep the two valve bodies 48 and 49 in contact with each other. This delays the timing when the inflation gas starts flowing from the upper inflation chamber 33 through the opening 46 to the outside of the airbag 30.

Accordingly, the same advantage as the first embodiment is obtained in the sixth embodiment, although the holding portion differs in shape.

It should be apparent to those skilled in the art that the present invention may be embodied in many other specific forms without departing from the spirit or scope of the invention. Particularly, it should be understood that the present invention may be embodied in the following forms.

Gas Discharge Devices 25, 26, 61

The gas discharge portion 26a and the second gas discharge portion 61b may start discharging inflation gas at the second timing, which is earlier than the first timing of the gas discharge portion 25a and the first gas discharge portion 61a.

When three or more gas discharge portions are arranged, the gas discharge portions may include gas discharge portions that start discharging inflation gas at the first timing and the second timing and include gas discharge portions that start discharging inflation gas at a timing that differs from the first timing and the second timing.

The number of gas discharge portions that start discharging inflation gas at the first timing may be one or more. In the same manner, the number of gas discharge portions that start discharging inflation gas at the second timing may be one or more.

Horizontal Partition 31 and Vertical Partition 32

At least one of the horizontal partition 31 and the vertical partition 32 may be a seam instead of the tether.

As described above, the tether is formed by arranging a fabric piece between the vehicle outer side and the vehicle inner side of the airbag 30 folded in half in the vehicle widthwise direction and coupling the two sides of the fabric piece in the vehicle widthwise direction to the vehicle outer portion and the vehicle inner portion of the airbag 30.

The seam is formed by coupling the vehicle outer portion and the vehicle inner portion of the airbag with the vehicle outer portion and the vehicle inner portion in contact with each other. The typical coupling means is, for example, sewing using a sewing yarn.

Inflation Chambers

The entire airbag 30 may include inflation chambers as described in each of the above embodiments. Alternatively, part of the airbag 30 may include non-inflation portions that are not supplied with inflation gas and inflated.

The airbag 30 may be divided into two inflation chambers. In this case, for example, the vertical partition 32 of the first embodiment is omitted, and the rear lower inflation chamber 34 and the front lower inflation chamber 35 are integrated. The upper and lower inflation chambers are independent inflation chambers. Each inflation chamber serves as a discharge inflation chamber. The first gas discharge portion is arranged in one of the inflation chambers, and the second gas discharge portion is arranged in the other one of the inflation chambers.

Further, the airbag 30 may be divided into four or more inflation chambers. In this case, only one inflation chamber may be an independent inflation chamber. Alternatively, two or more inflation chambers may be independent inflation chambers.

When two or more inflation chambers may be independent inflation chambers, two or more inflation chambers including all the independent inflation chambers serve as discharge inflation chambers that respectively include gas discharge portions.

At least two of the gas discharge portions are the first gas discharge portion and the second gas discharge portion. The gas discharge portion arranged in at least one independent inflation chamber is the first gas discharge portion.

Pressure-Regulating Valve 47

Instead of the pressure-regulating valve of each of the above embodiments, a pressure-regulating valve that substantially closes (slightly opens) before satisfying the condition that the internal pressure of the upper inflation chamber 33 exceeds a predetermined value and opens when satisfying the condition may be used as the pressure-regulating valve of each embodiment.

For example, when the modified example is applied to the first embodiment, the two overlapping portions 43 overlap each other in the pressure-regulating valve 47 at the beginning of the supply of inflation gas to the upper inflation chamber 33. The two overlapping portions 43 close the opening 46 and restrict the flow of the inflation gas from the upper inflation chamber 33 through the opening 46 to the outside of the airbag 30. This accumulates the inflation gas in the upper inflation chamber 33 and increases the internal pressure of the upper inflation chamber 33. The shoulder PS of the dummy D1 is pressed by the upper inflation chamber 33 having increased internal pressure, and the dummy D1 is moved toward the middle of the automobile.

When the inflation gas increases the internal pressure of the upper inflation chamber 33, the two overlapping portions 43 are deformed. The deformation of the two overlapping portions 43 decreases the overlapping amount of the two overlapping portions 43. When the overlapping amount of the two overlapping portions 43 becomes zero and opens the opening 46, the outward flow of the inflation gas is permitted. This causes the inflation gas in the upper inflation chamber 33 to flow from the open portion of the opening 46 to the outside and decreases the internal pressure of the upper inflation chamber 33.

In at least one of the first to sixth embodiments, the pressure-regulating valve does not have to be arranged. Instead, an exhaust means such as a vent hole (exhaust hole) may be arranged.

Holding Portion

The tear seam 51 of the first embodiment may be a means that differs from a sewing yarn. For example, the tear seam 51 may be formed by applying an adhesive in a continuous manner or in an intermittent manner and bonding the two valve bodies 48 and 49 to each other.

Further, the tear seam 51 may be arranged at a plurality of portions of the two valve bodies 48 and 49 in the vehicle widthwise direction.

In the first embodiment, the length of the tear seam 51 is longer than the length between the two coupling portions 45 separated from each other in the vehicle widthwise direction with the opening 46 located in between, and the tear seam 51 traverses the two coupling portions 45. Instead, the length of the tear seam 51 may be shorter than the length between the two coupling portions 45.

As shown in FIG. 14, in the first embodiment, the tear seam 51 including the holding portion may extend in the front-to-rear direction instead of the vehicle widthwise direction.

In the fourth embodiment, instead of the adhesive layer 66, a viscous layer (not shown) may be arranged as the holding portion. In this case, the viscous layer is formed between the two valve bodies 48 and 49 that are proximate to each other, and the viscous force couples the two valve bodies 48 and 49. Until a certain time of the period during which the inflation chamber 33 restrains the shoulder PS, the viscous layer is not torn and maintains the coupling (viscosity) of the two valve bodies 48 and 49. Subsequent to the certain time of the restraint period, the viscous layer is torn to allow for separation of the two valve bodies 48 and 49 (opening of pressure-regulating valve 47).

The adhesive layer 66 of the fourth embodiment may be arranged on the entire surfaces of the valve bodies 48 and 49 or arranged on portions of the valve bodies 48 and 49 in a planar manner. The same applies to the viscous layer, which is arranged instead of the adhesive layer 66.

In at least one of the first to sixth embodiments, the holding portion may be omitted.

Opening/Closing Valve 62

An opening/closing valve that opens and closes a gas supply passage may be arranged at one or both of the gas supply passage that supplies the first gas discharge portion with inflation gas and the gas supply passage that supplies the second gas discharge portion with inflation gas. For example, in the second embodiment, an opening/closing valve may be arranged in the gas supply passage 63 instead of or in addition to the opening/closing valve 62 of the gas supply passage 64.

Accommodation Portion 18 of Airbag Module ABM

The accommodation portion 18 may be arranged at the side wall 11 of the automobile 10 instead of the seat back 14 of the automobile seat 12, and the airbag module ABM may be incorporated in the accommodation portion 18.

Other Components

The side airbag device is applicable to an automobile seat 12 arranged in an automobile facing a direction other than the forward direction. For example, if the automobile seat 12 is arranged so that the seat back 14 is directed in a sideward direction, the side airbag device may be applied to protect an occupant from an impact applied to the vehicle in a sideward direction of the automobile seat 12 (front-rear direction of automobile).

The side airbag device is applicable to a side airbag device that protects, from an impact, a portion of the side of an occupant that differs from each of the above embodiments.

The airbag device may be applied to an airbag device that provides a gas discharge device with an activation signal that activates the gas discharge device and discharges inflation gas out of the gas discharge portion when a sensor detects application of an impact to an automobile instead of prediction of an impact.

The airbag device is applicable to an airbag device that protects an occupant from an impact when the impact is applied to the automobile from a direction that differs from the sideward direction or when the application of the impact is predicted.

The automobile to which the airbag device is applied includes not only private cars but also various industrial automobiles.

The airbag device is applicable to an airbag device that is arranged in a vehicle other than an automobile, for example, an airplane or a ship and protects an impact from an occupant sitting in a vehicle seat.

The present examples and embodiments are to be considered as illustrative and not restrictive, and the invention is not to be limited to the details given herein, but may be modified within the scope and equivalence of the appended claims.

1. An airbag device comprising:
a gas discharge device including a plurality of gas discharge portions that discharge inflation gas; and
an airbag deployed and inflated by the inflating gas discharged from the gas discharge portions, wherein
the airbag is divided into a plurality of inflation chambers,
at least one of the inflation chambers is an independent inflation chamber that restricts flow of inflation gas to and from adjacent ones of the inflation chambers,
two or more of the inflation chambers including all the independent inflation chambers are discharge inflation chambers, each including the gas discharge portion,
at least two of the gas discharge portions include a first gas discharge portion that starts discharging the inflation gas at a first timing and a second gas discharge portion that starts discharging the inflation gas at a second timing, which differs from the first timing, and
the first discharge portion is arranged in at least one of the independent inflation chambers.

2. The airbag device according to claim 1, wherein
the gas discharge device is one of a plurality of gas discharge devices,
the gas discharge devices respectively include the gas discharge portions,
the gas discharge devices are respectively arranged in the discharge inflation chambers, and
the gas discharge portion of each of the gas discharge devices is arranged in the corresponding one of the discharge inflation chambers.

3. The airbag device according to claim 1, wherein
the gas discharge portions all share a common gas discharge device,
the gas discharge device includes a plurality of gas supply passages that supply the gas discharge portions with the inflation gas,
the gas supply passages are configured to supply each of the first gas discharge portion and the second gas discharge portion with the inflation gas, and
at least one of the gas supply passages includes an opening/closing valve that opens and closes the corresponding gas supply passage.

4. The airbag device according to claim 1, wherein
the airbag is a side airbag deployed and inflated between an AM50 dummy, which is seated in a correct posture on a vehicle seat installed in a vehicle, and a side wall of the vehicle located beside the AM50 dummy,
the at least one independent inflation chamber of the discharge inflation chambers is a shoulder protection independent inflation chamber deployed and inflated beside a shoulder of the AM50 dummy,
the first gas discharge portion that starts discharging the inflation gas at the first timing is arranged in the shoulder protection independent inflation chamber,
the second gas discharge portion is arranged in at least one of the discharge inflation chambers that differs from the shoulder protection independent inflation chamber of the discharge inflation members, and
the second discharge portion starts discharging the inflation gas at the second timing, which is delayed from the first timing.

5. The airbag device according to claim 1, wherein
the airbag is a side airbag deployed and inflated beside an AM50 dummy, which is seated in a correct posture in a vehicle seat installed in a vehicle, to restrain the AM50 dummy,
the independent inflation chamber includes an opening and a pressure-regulating valve located at a portion that is non-adjacent to other inflation chambers, and
the pressure-regulating valve is configured to
close and restrict outward flow of the inflation gas from the independent inflation chamber through the opening before the independent inflation chamber restrains the AM50 dummy, and
open and permits the outward flow of the inflation gas in accordance with a change in a tensioned state of the independent inflation chamber resulting from an external force produced by the restraint when the independent inflation chamber restrains the AM50 dummy.

6. The airbag device according to claim 5, wherein
the pressure-regulating valve includes two valve bodies located around the opening, and
the pressure-regulating valve is configured to
close when the inflation gas presses the two valve bodies so that the valve bodies contact or approach each other before the independent inflation chamber restrains the AM50 dummy, and
open when an external force produced by the restraint deforms and separates the two valve bodies from each other as the independent inflation chamber restrains the AM50 dummy.

7. The airbag device according to claim 6, further comprising a holding portion that keeps the pressure-regulating valve closed until a certain time of a period during which the independent inflation chamber restrains the AM50 dummy and releases the pressure-regulating valve subsequent to the certain time of the period.

8. The airbag device according to claim 7, wherein the holding portion is a tear seam that couples the two valve bodies in contact with each other or proximate to each other.

9. The airbag device according to claim 7, wherein the holding portion is an auxiliary fabric traversing the independent inflation chamber in a state in which the auxiliary fabric overlaps one of the two valve bodies of the closed pressure-regulating valve.

10. The airbag device according to claim 7, wherein
the holding portion includes a first friction portion formed in at least part of one of the two valve bodies and a second friction portion formed in at least part of the other one of the two valve bodies, wherein
the second holding portion generates a friction force by contacting the first friction portion when the pressure-regulating valve closes.
